(19) United States
(12) Patent Application Publication
(10) Pub. No.: US 2016/0099471 A1
(43) Pub. Date: Apr. 7, 2016

(54) POSITIVE ELECTRODE HAVING ENHANCED CONDUCTIVITY AND SECONDARY BATTERY INCLUDING THE SAME

(71) Applicant: LG CHEM, LTD., Seoul (KR)

(72) Inventors: Sei Woon Oh, Daejeon (KR); Eun Ju Lee, Daejeon (KR); In Chul Kim, Daejeon (KR); JungAh Shim, Daejeon (KR)

(73) Assignee: LG CHEM, LTD., Seoul (KR)

(21) Appl. No.: 14/862,294

(22) Filed: Sep. 23, 2015

(30) Foreign Application Priority Data
Oct. 2, 2014 (KR) 10-2014-0133017

(51) Int. Cl. H01M 4/66; H01M 4/04; H01M 4/505; H01M 4/131; H01M 4/525

(52) U.S. Cl. CPC H01M 4/663; H01M 4/131; H01M 4/525; H01M 4/505; H01M 4/0404; H01M 4/0428; H01M 4/0416; H01M 2004/028

(57) ABSTRACT

Disclosed is a positive electrode for secondary batteries including a positive electrode mix coated on a current collector. More particularly, disclosed are a positive electrode for secondary batteries including a positive electrode mix coated on a current collector and a secondary battery including the same, wherein the current collector includes carbon nanotubes (CNTs) vertically grown from a surface of the current collector, the positive electrode mix contact the current collector in a state that at least a portion of the positive electrode mix is interposed in a space between the carbon nanotubes, and the positive electrode has high conductivity and safety.

### CROSS-REFERENCE TO RELATED APPLICATIONS

The present application claims priority from Korean Application No. 10-2014-0133017 filed Oct. 2, 2014, the disclosure of which is hereby incorporated herein by reference.

### TECHNICAL FIELD

The present invention relates to a positive electrode for secondary batteries including a positive electrode mix coated on a current collector. More particularly, the present invention relates to a positive electrode for secondary batteries wherein CNTs are vertically grown in a surface of a current collector and at least a portion of the positive electrode mix is disposed between the CNTs.

### BACKGROUND ART

In line with rapid increase in use of fossil fuels, demand for alternative energy or clean energy is increasing. Thus, the field of power generation and electrochemical electricity storage is most actively studied.

As a representative example of electrochemical devices using electrochemical energy, secondary batteries are currently used and use thereof is gradually expanding.

Recently, as technical development and demand for portable devices such as smartphones, notebooks, wearable devices, cameras, etc. increase, demand for secondary batteries as energy sources is rapidly increasing. Among secondary batteries, research on lithium secondary batteries, which exhibit high energy density and operation potential and have long cycle life and low self-discharge rate, is underway and such lithium secondary batteries are commercially available and widely used.

In addition, as interest in environmental problems is increasing, research into electric vehicles, hybrid electric vehicles, and the like that can replace vehicles using fossil fuels, such as gasoline vehicles, diesel vehicles, and the like, which are one of the main causes behind air pollution, is actively underway. As a power source of electric vehicles, hybrid electric vehicles, and the like, a secondary battery is used.

Such a lithium secondary battery has a structure wherein an electrode assembly composed of a positive electrode including a lithium transition metal oxide as an active material, a negative electrode including a carbon-based active material and a separator is impregnated with a lithium electrolyte. The positive electrode and the negative electrode are manufactured by coating an electrode mix on a current collector, and the electrode mix is prepared by mixing an electrode mix composed of an electrode active material for storing energy, a conductive material for providing electric conductivity and a binder for adhering to electrode foil, and a dispersion medium such as water, NMP, etc.

In general, a conductive material is added to an electrode mix to enhance electric conductivity of an active material. In particular, since a lithium transition metal oxide used as a positive electrode active material has low electric conductivity, adding a conductive material to a positive electrode mix is essential.

Such a conductive material is added in an amount of about 3 to about 15% by weight based on the weight of a positive electrode mix. When the conductive material is used in too small an amount, interior resistance of a positive electrode increases and thus battery performance is decreased. On the other hand, when the conductive material is used in too large an amount, the content of binder should be increased and thus the content of active material is decreased, thereby leading to battery capacity reduction, dispersibility decrease, etc.

Meanwhile, when a current collector foil is coated with a positive electrode mix, a foil surface becomes smooth and thus adhesion to an active material and conductivity are not secured, whereby it is not easy to secure stable conductivity. In addition, when a positive electrode mix is thickly coated to secure higher capacity, it is difficult to evenly disperse a conductive material composed of small particles, whereby uniform conductivity is not guaranteed and slurry properties are deteriorated.

Accordingly, there is an urgent need for technology to address such problems.

### DISCLOSURE

### Technical Problem

Therefore, the present invention has been made to solve the above and other technical problems that have yet to be resolved.

As a result of a variety of extensive and intensive studies and experiments, the inventors of the present invention confirmed that, when carbon nanotubes (CNTs) are vertically grown in a surface of a current collector and a positive electrode mix contacts a current collector in a state that at least a portion of the positive electrode mix is interposed in a space between carbon nanotubes as described below, adhesion between a positive electrode active material and the current collector is enhanced and an entire positive electrode mix coating layer has uniform and high conductivity. Accordingly, capacity characteristics and rate performance are enhanced and the content of a conductive material included in the mixture is decreased, and thus, slurry characteristics may be secured, thereby completing the present invention.

### Technical Solution

Accordingly, a positive electrode for secondary batteries according to the present invention includes a positive electrode mix including a positive electrode active material coated on a current collector, wherein the current collector includes carbon nanotubes vertically grown from a surface of the current collector, and the positive electrode mix contacts the current collector in a state that at least a portion of the positive electrode mix is interposed in a space between the carbon nanotubes.

The positive electrode for secondary batteries according to the present invention has a structure wherein the positive electrode mix is interposed in a space between the carbon nanotubes grown vertically in a metallic current collector at a predetermined interval. Accordingly, swelling is induced only in a thickness direction of the positive electrode, and, compared to a smooth current collector, adhesion between the active material and the current collector is enhanced.

In addition, even when the positive electrode mix disposed between the vertically grown carbon nanotubes includes a small amount of conductive material, conductivity may be secured through a network with the entirely distributed carbon nanotubes. Accordingly, it is easy to secure dispersibility of a positive electrode mix slurry, and strong bonding force and fixation force are increased by increasing contact areas to the carbon nanotubes grown in the positive electrode mix and the current collector.

In addition, carbon nanotubes arranged in the same direction facilitate migration of lithium ions, compared to irregularly arranged carbon nanotubes, and thus, a solid electrolyte interphase (SEI) layer is stably formed and reversible capacity is secured, thereby enhancing capacity characteristics and rate performance.

That is, the positive electrode for secondary batteries according to the present invention includes the carbon nanotubes, which are vertically grown from the current collector, and the positive electrode mix, at least a portion of which is disposed between the carbon nanotubes, thereby having superior conductivity, capacity and rate performance. Hereinafter, a composition of the positive electrode for secondary batteries according to the present invention is described in more detail.

In the current collector, electrons migrate through electrochemical reaction of an active material, and the current collector is generally manufactured to a thickness of 3 to 500 μm. The positive electrode current collector is not particularly limited so long as it does not cause chemical changes in the fabricated secondary battery and has high conductivity. For example, the positive electrode current collector may be made of stainless steel, aluminum (Al), nickel (Ni), titanium (Ti), sintered carbon, or aluminum or stainless steel surface-treated with carbon, nickel, titanium, silver, or the like.

The positive electrode current collector may have fine irregularities at a surface thereof to increase bonding force to an active material. The positive electrode current collector may be used in any of various forms including films, sheets, foils, nets, porous structures, foams, and non-woven fabrics, but the present invention is not limited thereto.

These current collectors have minute irregularities at a surface thereof and thus may increase bonding force to an active material. The current collectors may be used in any of various forms including films, sheets, foils, nets, porous structures, foams, and non-woven fabrics, but the present invention is not limited thereto.

Next, the carbon nanotubes vertically grown in the current collector have a shape wherein one or more graphite layers are rolled, and have high conductivity and a wide surface area. Carbon nanotubes have both zigzag and armchair shapes. These shapes are dependent upon an arrangement state of a hexagonal ring structure when a graphite layer is rolled into a concentric circle with respect to an axis of a nanotube. That is, properties and shapes of the carbon nanotubes depend upon an angle when wound into a spiral shape with respect to a coaxial shaft of a tube. A carbon nanotube has an armchair shape when there is a hexagonal diagonal vector constituting a graphite layer upon being wound into a concentric circle, and a carbon nanotube has a zigzag shape when there is a vector in a vertical direction to the hexagonal side upon being wound into a concentric circle.

Such carbon nanotubes may have an average vertical growth length of 1 to 200 μm, particularly 5 to 150 μm. Outside the range, when the average vertical growth length is greater than 200 μm, the thickness of the positive electrode mix increases, and a resultant positive electrode mix, the thickness of which is increased, has decreased electrolyte wettability. When the carbon nanotubes have an average vertical growth length of less than 1 μm, it is difficult to secure desired conductivity. In addition, the thickness of the positive electrode mix is decreased depending upon the length of the carbon nanotubes, and thus, battery capacity is decreased.

In addition, the carbon nanotubes may have an average diameter of 0.4 to 20 nm. In particular, the carbon nanotubes may have a single wall structure or a multi-wall structure. When the carbon nanotubes have a single wall structure, an average diameter thereof is generally 0.4 to 2 nm. When the carbon nanotubes have a multi-wall structure, an average diameter thereof is generally 10 to 20 nm.

Conductivity of the carbon nanotubes is intimately related to chirality of each tube. Since single-walled carbon nanotubes (SWCNTs) have single-chirality, conductivity may be easily controlled. Since multi-walled carbon nanotubes (MWCNTs) have multi-chirality, it is difficult to control conductivity, but it is possible to insert lithium ions between graphene layers and to intercalate lithium ions. Accordingly, a layer structure becomes stable, and an SEI film may be easily formed due to surface area increase by a multi-layer structure, thus being more preferably used in lithium secondary batteries.

Accordingly, the average diameter of the carbon nanotubes is preferably 0.4 to 20 nm. In regard to multi-wall formation, the average diameter of the carbon nanotubes is more preferably 10 to 20 nm Outside this range, when an average diameter of the carbon nanotubes is less than 0.4 nm, it is difficult to secure desired conductivity and formation of SWCNTs may be difficult. When an average diameter of the carbon nanotubes is greater than 20 nm, time and costs substantially increase.

In addition, the carbon nanotubes may be included in an amount of 0.1 to 10% based on the total weight of the positive electrode mix. Outside this range, when the mass of nanotubes grown in the current collector is less than 0.1%, it is difficult to obtain desired effects. On the other hand, when nanotubes are included in a mass of greater than 10%, the amount of active material is relatively decreased and capacity may be decreased due to inclusion of a conductive material unnecessary in capacity expression. For the same reason, the carbon nanotubes may be included in an amount of 0.3 to 9%, more particularly 0.5 to 7% based on the total weight of the positive electrode mix.

Next, a positive electrode mix generally denotes a solid content remaining after preparing a slurry by dispersing a positive electrode active material, a binder and a conductive material in a dispersion medium and then volatilizing the dispersion medium by coating and drying the slurry on a current collector.

The positive electrode for secondary batteries according to the present invention may or might not include a conductive material. That is, a conductive material of the positive electrode mix may be substituted with the carbon nanotubes vertically grown in the current collector. Alternatively, a small amount of a conductive material may be included in the positive electrode mix, thereby exhibiting excellent conductivity through interaction with the vertically grown carbon nanotube.

In general, a conductive material has low miscibility to a dispersion medium and thus it is difficult to disperse and diffuse solids. Accordingly, a slurry including a large amount of conductive material is not uniform, which deteriorates battery properties. Such a phenomenon is further intensified by sedimentation occurring when an evaporation amount of a dispersion medium increases or waiting time for slurry-coating is extended.

Accordingly, when the content of conductive material is increased to manufacture a high-capacity battery, processability is deteriorated. The positive electrode for secondary batteries according to the present invention may secure a sufficient conductivity using a small amount of conductive material in a mixture even when a relatively wide conductivity range is secured, thereby enhancing processability. In addition, due to interaction between the carbon nanotubes vertically grown in the current collector and the conductive material included in a slurry, conductivity may be stably secured without a congested area even when the mixture coating layer is thick.

Such a conductive material is an ingredient for further enhancing conductivity of an active material. When a conductive material is included in a positive electrode mix, the positive electrode mix may be included in an amount of 0.1% by weight to 10% by weight, in particular 0.1% by weight to 5% by weight, more particularly 0.1% by weight to 4% by weight based on the total weight of the positive electrode mix. Even when the conductive material is included in a relatively small amount, predetermined conductivity may be secured through interaction with the carbon nanotube vertically grown in the current collector.

There is no particular limit as to the conductive material, so long as it does not cause chemical changes in the fabricated battery and has conductivity. Examples of conductive materials include graphite such as natural or artificial graphite; carbon black such as carbon black, acetylene black, Ketjen black, channel black, furnace black, lamp black and thermal black; carbon derivatives such as carbon nanotubes and fullerenes; conductive fibers such as carbon fibers and metallic fibers; metallic powders such as carbon fluoride powder, aluminum powder and nickel powder; conductive whiskers such as zinc oxide and potassium titanate; conductive metal oxides such as titanium oxide; and polyphenylene derivatives.

The binder is a component assisting in binding between the active material and the conductive material and in binding of the electrode active material to the current collector. The binder is typically added in an amount of 1 to 50 wt % with respect to the total weight of the mixture including the positive electrode active material. Examples of the binder include polyvinylidene fluoride, polyvinyl alcohols, carboxymethylcellulose (CMC), starch, hydroxypropylcellulose, regenerated cellulose, polyvinyl pyrrolidone, tetrafluoroethylene, polyethylene, polypropylene, ethylene-propylene-diene terpolymer (EPDM), sulfonated EPDM, styrene-butadiene rubber, fluorine rubber, and various copolymers.

Meanwhile, the positive electrode active material is not specifically limited so long as lithium ions may be intercalated and deintercalated. In particular, the positive electrode active material may be a lithium transition metal oxide including at least one selected from the group consisting of nickel (Ni), cobalt (Co) and manganese (Mn).

More particularly, lithium transition metal oxide includes two or more transition metals and, for example, may be a layered compound such as a lithium cobalt oxide (LiCoO₂), lithium nickel oxide (LiNiO₂) and the like substituted with one or more transition metals; lithium manganese oxide substituted with one or more transition metals; lithium nickel-based oxide represented by formula, LiNi_{1-y}M_{y}O₂ (where M includes at least one of Co, Mn, Al, Cu, Fe, Mg, B, Cr, Zn and Ga, and 0.01≦y≦0.7); and a lithium nickel cobalt manganese complex oxide represented by Li_{1+z}Ni_{b}Mn_{c}Co_{1-(b+c+d)}M_{d}O₍₂₋ₑ₎Aₑ (where −0.5≦z≦0.5, 0.1≦b≦0.8, 0.1≦c≦0.8, 0≦d≦0.2, 0≦e≦0.2 and b+c+d<1, M is Al, Mg, Cr, Ti, Si or Y, and A is F, P or Cl) such as Li_{1+z}Ni_{1/3}Co_{1/3}Mn_{1/3}O₂, Li_{1+z}Ni_{0.4}Mn_{0.4}Co_{0.2}O₂ and the like.

The above lithium transition metal oxides used as a positive electrode active material have low electric conductivity and thus a conductive material is generally added thereto. Such a conductive material has a minute particle size and thus dispersibility of a slurry is deteriorated, thereby deteriorating processability.

In addition, a positive electrode manufactured from a slurry having non-uniform dispersibility as described above leads to physical or electrochemical problems. Accordingly, when a secondary battery is manufactured using the positive electrode, capacity characteristics, rate characteristics, and overall battery properties may be deteriorated.

In the positive electrode for secondary batteries according to the present invention, carbon nanotubes are vertically grown at a predetermined interval in a current collector, and the positive electrode mix is interposed in a space between carbon nanotubes. Accordingly, the content of conductive material in a slurry is reduced and, at the same time, a positive electrode manufactured using the slurry has sufficient conductivity. In addition, processability in slurry production is enhanced.

The positive electrode mix may further include at least one material selected from the group consisting of a viscosity control agent and a filler, other than a positive electrode active material, a conductive material and a binder.

The viscosity control agent is an ingredient for controlling the viscosity of a positive electrode mix so as to facilitate a mixing process of a positive electrode mix and a process of spreading the same over a collector and may be added in an amount of maximally 30% by weight based on the total weight of the positive electrode mix. Examples of such a viscosity control agent include carboxymethylcellulose, polyacrylic acids, etc., but the present invention is not limited thereto.

The filler is used as an aid to inhibit positive electrode expansion and is not particularly limited so long as it is a fibrous material that does not cause chemical changes in the fabricated secondary battery. Examples of the filler include olefin-based polymers such as polyethylene and polypropylene; and fibrous materials such as glass fiber and carbon fiber.

Meanwhile, the carbon nanotubes are preferably formed at an interval of 0.1 to 100 μm. In addition, the carbon nanotubes may be formed at a constant interval.

Outside the range, when an interval between the carbon nanotubes is greater than 100 μm, it is difficult to form a minute electron migration network. When an interval between the carbon nanotubes is less than 0.1 μm, it is difficult to introduce a positive electrode mix slurry into the vertically grown carbon nanotubes. For the same reason, an interval between the carbon nanotubes may be 1 μm to 80 μm, more particularly 5 μm to 60 μm.

That is, the positive electrode for secondary batteries according to the present invention is manufactured by forming a positive electrode mix coating layer through coating of a slurry for the positive electrode mix after vertically growing carbon nanotubes on a surface of the current collector. Here, an interval between the carbon nanotubes may be controlled to secure high conductivity within a range within which the positive electrode mix slurry is introduced between the carbon nanotubes.

Hereinafter, a method of forming an internal between the carbon nanotubes and a method of vertically growing are described in more detail.

Meanwhile, the positive electrode mix may form a coating layer in a state that the carbon nanotubes are embedded therein. In addition, the positive electrode mix may form a coating layer to a vertically grown height of the carbon nanotubes.

When a coating layer wherein the thickness of the coating layer is smaller than a vertical length of the carbon nanotube is formed, an electrode surface may be non-uniform. When a coating layer wherein the thickness of the coating layer is larger than a vertical length of the carbon nanotube is formed, conductivity may be decreased in a portion in which the carbon nanotubes are not present.

In addition, the present invention provides a method of manufacturing a positive electrode for secondary batteries including a positive electrode mix that includes a positive electrode active material on a current collector, wherein the current collector includes carbon nanotubes vertically grown from a surface thereof, and the positive electrode mix contacts the current collector in a state that at least a portion of the positive electrode mix is interposed in a space between the carbon nanotubes.

In particular, the manufacturing method includes:

(a) vertically growing carbon nanotubes on a surface of a current collector;

(b) preparing a slurry for a positive electrode mix; and

(c) coating the slurry for a positive electrode mix on the current collector, in which the carbon nanotubes are vertically grown, and then drying the same.

In order to more particularly describe the manufacturing method, a method of manufacturing a positive electrode for secondary batteries is schematically illustrated in FIG. 1.

Referring to FIG. 1, in the vertically growing (a), carbon nanotubes are vertically grown in a surface of a current collector, and the carbon nanotubes may be vertically grown in a current collector using a carbon source including a catalyst and aromatic hydrocarbon under a condition of high temperature of 800° C. to 1200° C. and an inert gas atmosphere such as argon, etc.

In particular, the vertically growing (a) may be carried out by forming catalyst concentration areas, at an interval of 0.1 to 100 μm, in the current collector and vertically growing the carbon nanotubes in each of the catalyst concentration areas.

More particularly, the vertical growth process may be carried out through a CVD method, a PECVD method, or the like. In order to grow the carbon nanotubes separated by a predetermined interval, catalyst concentration areas separated by a predetermined interval are formed in a current collector using pre-heating or a laser, before growing the carbon nanotubes.

Here, an interval between the catalyst concentration areas may be constant.

In such catalyst concentration areas, carbon nanotubes grow, and one carbon nanotube or multiple carbon nanotubes may be formed per area. The size and density of the areas may be controlled with a zeolite catalyst, etc. considering the thickness of the current collector.

In the preparing (b), a positive electrode slurry constituting the positive electrode mix is prepared. The positive electrode slurry is prepared by mixing a positive electrode active material, a conductive material, a binder, etc. with a dispersion medium. As described above, as the positive electrode active material, a lithium transition metal oxide including at least one selected from the group consisting of nickel, cobalt, and manganese may be used. The slurry constituting the positive electrode mix does not include a conductive material or includes a small amount of conductive material, thereby alleviating property deterioration of the slurry.

The dispersion medium is not specifically limited and, preferably, a material, a polymer particle shape of which may be maintained when the positive electrode slurry according to the present invention is coated and dried on a current collector and which is a liquid at normal temperature and pressure, is preferable. Examples of the dispersion medium, but do not limited to, include water; alcohols such as methanol, ethanol, propanol, isopropanol, butanol, isobutanol, s-butanol, t-butanol, pentanol, isopentanol, hexanol, etc.; ketones such as acetone, methylethylketone, methylpropylketone, ethylpropylketone, cyclopentanone, cyclohexanone, cycloheptanone, etc.; ethers such as methylethylether, diethylether, dipropylether, diisopropylether, dibutylether, diisobutylether, di-n-amylether, diisoamylether, methylpropylether, methylisopropylether, methylbutylether, ethylpropylether, ethylisobutylether, ethyl-n-amylether, ethylisoamylether, tetrahydrofuran, etc.; lactones such as gamma-butyrolactone, delta-butyrolactone, etc.; lactam such as beta-lactam, etc.; and electrolyte dispersion media described below. The dispersion medium may be a mixture of two or more media.

As such, a slurry prepared through (b) the preparing is used in a positive electrode for secondary batteries by being coated and then dried on the current collector in which the carbon nanotubes are vertically grown according to (c) the coating.

The manufactured positive electrode for secondary batteries has an increased contact area to a current collector and an active material, and thus, adhesion is enhanced and conductivity may be efficiently secured. In addition, as illustrated in FIG. 1, the vertically grown carbon nanotubes may control expansion direction of the positive electrode mix.

That is, an expansion direction of an electrode is generally vertical, but an electrode may expand in any direction according to a charge/discharge process. Here, the shape and volume of each electrode included in a battery may be somewhat different. However, since, in the positive electrode for secondary batteries according to the present invention, the CNTs vertically grown in the current collector guide an expansion direction, predictability of the expansion direction may be increased.

In addition, the present invention provides a lithium secondary battery including the positive electrode for secondary batteries. The lithium secondary battery includes, along with the positive electrode, a negative electrode, a lithium-containing non-aqueous-based electrolyte which functions as a medium through which lithium ions migrate between the negative electrode and the positive electrode, and a separator.

The negative electrode is manufactured by coating a negative electrode mix including a negative electrode active material on a current collector in a manner similar to the positive electrode. The negative electrode active material may be, for example, carbon and graphite materials such as natural graphite, artificial graphite, expandable graphite, carbon fiber, hard carbon, carbon black, carbon nanotubes, fullerenes, and activated carbon; metals alloyable with lithium such as Al, Si, Sn, Ag, Bi, Mg, Zn, In, Ge, Pb, Pd, Pt, Ti, and the like and compounds including these elements; complexes of metals and compounds thereof and complexes of carbon and graphite materials; lithium-containing nitrides; or the like.

The lithium-containing non-aqueous electrolyte is composed of a non-aqueous electrolyte and a lithium salt.

Examples of the non-aqueous electrolyte include aprotic organic dispersion media such as N-methyl-2-pyrrolidone, N-methyl-2-pyrrolidone carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

The lithium salt is a material that is readily soluble in the non-aqueous electrolyte and examples thereof include, but are not limited to, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, (CF₃SO₂)₂NLi, chloroborane lithium, lower aliphatic carboxylic acid lithium, lithium tetraphenyl borate, and imides.

As desired, an organic solid electrolyte, an inorganic solid electrolyte and the like may be used.

Examples of the organic solid electrolyte include polyethylene derivatives, polyethylene oxide derivatives, polypropylene oxide derivatives, phosphoric acid ester polymers, polyagitation lysine, polyester sulfide, polyvinyl alcohols, polyvinylidene fluoride, and polymers containing ionic dissociation groups.

Examples of the inorganic solid electrolyte include, but are not limited to, nitrides, halides and sulfates of lithium (Li) such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

In addition, in order to improve charge/discharge characteristics and flame retardancy, for example, pyridine, triethylphosphite, triethanolamine, cyclic ether, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride or the like may be added to the non-aqueous electrolyte. If necessary, in order to impart incombustibility, the non-aqueous electrolyte may further include halogen-containing dispersion media such as carbon tetrachloride and ethylene trifluoride. Further, in order to improve high-temperature storage characteristics, the non-aqueous electrolyte may further include carbon dioxide gas, and fluoro-ethylene carbonate (FEC), propene sultone (PRS) and the like may be further included.

The separator is disposed between the positive electrode and the negative electrode. An insulating thin film having high ion permeability and mechanical strength is used as the separator. The separator typically has a pore diameter of 0.01 to 10 μm and a thickness of 5 to 300 μm. As the separator, sheets or non-woven fabrics made of an olefin polymer such as polypropylene, glass fibers or polyethylene, which have chemical resistance and hydrophobicity, are used. When a solid electrolyte such as a polymer is employed as the electrolyte, the solid electrolyte may also serve as both the separator and electrolyte.

The secondary battery according to the present invention may be used as a battery pack in a unit cell type. The battery pack may also be used as a unit cell in medium/large battery modules used as power sources of small devices and medium/large devices.

Particular embodiments of the device include, but are not limited to, computers, mobile phones, wearable electronic devices, power tools, electric vehicles (EVs), hybrid electric vehicles, plug-in hybrid electric vehicles, electric two-wheeled vehicles, electric golf carts, systems for storing power, etc.

The above devices or equipments are publicly known in the art, and thus, detailed descriptions thereof are omitted.

### Effects of Invention

As apparent from the fore-going, the positive electrode for secondary batteries according to the present invention includes a positive electrode mix coated on a current collector, wherein the current collector includes carbon nanotubes vertically grown from a surface thereof, and the positive electrode mix contacts a current collector in a state that at least a portion of the positive electrode mix is interposed in a space between the carbon nanotubes. Accordingly, even when a small amount of conductive material is included in the positive electrode mix, predetermined conductivity is secured, and thus, safety of a slurry is increased and carbon nanotubes arranged in the same direction secures electron diffusivity in an electrode thickness direction, thereby enhancing capacity and rate performance of a secondary battery.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a process of manufacturing a positive electrode for secondary batteries according to an embodiment of the present invention.

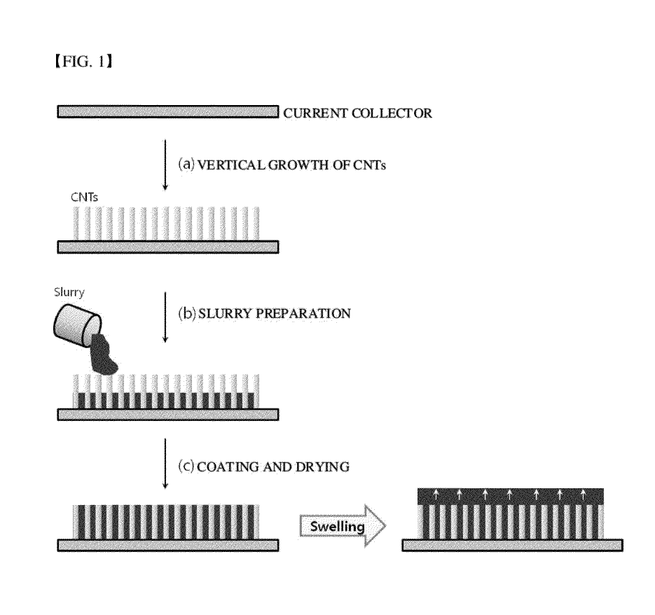

### BEST MODE

Now, the present invention will be described in more detail with reference to the following examples, comparative examples and experimental examples. These examples are provided only for illustration of the present invention and should not be construed as limiting the scope and spirit of the present invention.

### Example 1

### Manufacture of Positive Electrode for Secondary Batteries

Catalyst concentration areas were formed by heating a 25 μm aluminum current collector to 800° C. in the presence of Fe and Ni catalysts, and the current collector and a carbon source were loaded together in a CVD furnace under an Ar/H₂ atmosphere, followed by elevating from room-temperature to 750° C. Subsequently, cooling to 250° C. was carried out, and thus, CNTs were vertically grown in the catalyst concentration areas.

In a positive electrode mix slurry, N-methyl-2-pyrrolidone (NMP) was used as a dispersion medium, and 96 parts by weight of LiCoO₂ as a positive electrode active material, 2.2 parts by weight of Super-P as a conductive material and 1.5 parts by weight of PVdF as a binder were used based on the 100 parts by weight of the positive electrode mix (solid content).

The positive electrode mix slurry was coated and dried on a current collector including CNTs vertically grown therein and then pressed, thereby manufacturing a positive electrode for secondary batteries. Here, the vertically grown CNTs were included in an amount of 0.3 parts by weight based on the total weight of the positive electrode mix.

### Example 2

A positive electrode for secondary batteries was manufactured using the same process and contents as in Example 1, except that 2.0 parts by weight of Super-P as a conductive material and 0.5 parts by weight of vertically grown CNTs were used based on 100 parts of a positive electrode mix slurry.

### Comparative Example 1

In a positive electrode mix slurry, N-methyl-2-pyrrolidone (NMP) was used as a dispersion medium, and 96 parts by weight of LiCoO₂ as a positive electrode active material, 2.2 parts by weight of Super-P as a conductive material, 0.3 parts by weight of general CNTs, 1.5 parts by weight of PVdF as a binder were mixed based on 100 parts by weight of the positive electrode mix (solid content).

The positive electrode mix slurry was coated, dried, and then pressed on a current collector as in Example 1, except that, in the current collector, the general current collector CNTs were not vertically grown.

### Comparative Example 2

A positive electrode for secondary batteries was manufactured using the same process and contents as in Comparative Example 1, except that 2.0 parts by weight of Super-P as a conductive material and 0.5 parts by weight of general CNTs were used based on 100 parts of a positive electrode mix slurry.

### Comparative Example 3

A positive electrode for secondary batteries was manufactured using the same process and contents as in Comparative Example 1, except that 2.5 parts by weight of Super-P as a conductive material and 0 parts by weight of general CNTs were used based on 100 parts of a positive electrode mix slurry.

### Comparative Example 4

A positive electrode for secondary batteries was manufactured using the same process and contents as in Example 1, except that 96.5 parts by weight of LiCoO₂ as a positive electrode active material, 2.5 parts by weight of Super-P as a conductive material and 1 part by weight of PVDF were used.

### Experimental Example 1

### Conductivity Test

Penetration resistance of positive electrodes manufactured according to Examples and Comparative Examples was measured. Results are summarized in Table 1 below.

TABLE 1

| | Penetration resistance (Ω) |
|---|---|
| Example 1 | 22.114 |
| Example 2 | 18.186 |
| Comparative | 29.184 |
| Example 1 | |
| Comparative | 20.784 |
| Example 2 | |
| Comparative | 42.992 |
| Example 3 | |
| Comparative | 63.08 |
| Example 4 | |

Referring to Table 1, it can be confirmed that, although Example 1, Comparative Example 1, Example 2 and Comparative Example 2 include the same amount of Super-P and CNTs based on the total amount of the positive electrode, the examples that include vertically grown CNTs exhibit low resistance compared to the comparative examples that include general CNTs, and Examples 1 and 2 and Comparative Examples 1 and 2 including CNTs exhibit low resistance, i.e., high conductivity compared to Comparative Example 3 and 4 that do not include CNTs.

In the case of the vertically grown CNTs, conductive passages through which electrons penetrate in a thickness direction, i.e., a vertical direction, of the electrode are formed and thus uniform conductive passages are formed throughout the electrode. Accordingly, high conductivity is exhibited when compared to general CNTs in which conductive passages of electrons are randomly formed.

Meanwhile, when Examples 1 and 2 are compared, it can be confirmed that Example 2, in which a ratio of the vertical CNTs is higher, has higher conductivity, and, since the amount of the conductive material included in the positive electrode mix of Example 2 is smaller than that in Example 1, processability may be enhanced upon manufacturing a positive electrode according to Example 2, compared to the case of Example 1.

### Manufacture of Lithium Secondary Battery

### Example 3

Water was used as a dispersion medium in a negative electrode, and 98.3 parts by weight of a negative electrode active material, 0.5 parts by weight of PVdF as a binder and 1.2 parts by weight of CMC as a thickener were mixed based on 100 parts by weight of a negative electrode mix to prepare a negative electrode mix slurry. The prepared slurry was coated, dried and pressed on a current collector, thereby manufacturing a negative electrode.

A surface of a positive electrode plate manufactured according to Example 1 was punched into a size of 12.60 cm², and a surface of a negative electrode plate was punched into a size of 13.33 cm², thereby manufacturing a mono-cell. A tab was attached to upper portions of the positive electrode and a negative electrode, and a separator composed of a microporous polyolefin membrane was disposed between a negative electrode and a positive electrode. A resultant product was loaded in an aluminum pouch and then 500 mg of an electrolyte was injected into the pouch. An electrolyte was prepared by dissolving LiPF₆ electrolyte to a concentration of 1 M using a dispersion medium mixture that included ethyl carbonate (EC), diethyl carbonate (DEC) and ethyl-methyl carbonate (EMC) in a volume ratio of 4:3:3.

Subsequently, after sealing the pouch using a vacuum package machine and standing the same at room temperature for 12 hours, constant-current charging was performed in a ratio of about 0.05 C and constant-voltage charging, in which the same voltage is maintained until a current reached about ⅙ of initial current, was performed. At this time, gas occurred within a cell and thus degasification and resealing were performed, thereby manufacturing a lithium secondary battery.

### Comparative Example 5

A lithium secondary battery was manufactured in the same manner as in Example 3, except that a positive electrode for secondary batteries manufactured according to Comparative Example 1 was used.

### Experimental Example 2

Using the lithium secondary batteries manufactured according to Example 3 and Comparative Example 5, capacity thereof was measured according to a constant-current charge/discharge method. As a result, Example 3 and Comparative Example 5 exhibited similar initial capacity, but a capacity conservation ratio of respectively 88% and 82% after 800 cycles upon charge/discharge of 1 C/1 C. Accordingly, it can be confirmed that Example 3 exhibit excellent high-current characteristics.

As described above, the positive electrode used in Example 3 has conductive passages penetrated in a vertical direction, thus having increased resistance, compared to Comparative Example 5 in which conductive passages are randomly formed. Accordingly, by using the positive electrode according to the present invention including the vertically grown CNTs, a secondary battery having superior capacity and rate characteristics under high current may be provided.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A positive electrode for secondary batteries, comprising a positive electrode mix comprising a positive electrode active material coated on a current collector, wherein the current collector comprises carbon nanotubes (CNTs) vertically grown from a surface of the current collector, and the positive electrode mix contacts the current collector in a state that at least a portion of the positive electrode mix is interposed in a space between the carbon nanotubes.

2. The positive electrode according to claim 1, wherein the positive electrode mix comprises a conductive material.

3. The positive electrode according to claim 2, wherein the conductive material is comprised in an amount of 0.1 to 10% by weight based on a total weight of the positive electrode mix.

4. The positive electrode according to claim 1, wherein the positive electrode mix does not comprise a conductive material.

5. The positive electrode according to claim 1, wherein the positive electrode active material is a lithium transition metal oxide comprising at least one selected from the group consisting of nickel (Ni), cobalt (Co) and manganese (Mn).

6. The positive electrode according to claim 1, wherein the carbon nanotubes have an average vertical growth length of 1 to 200 μm.

7. The positive electrode according to claim 1, wherein the carbon nanotubes have an average vertical growth length of 5 to 150 μm.

8. The positive electrode according to claim 1, wherein the carbon nanotubes have an average diameter of 0.4 to 20 nm.

9. The positive electrode according to claim 1, wherein the carbon nanotubes have an average diameter of 10 to 20 nm.

10. The positive electrode according to claim 1, wherein the carbon nanotubes are comprised in a mass of 0.1 to 10% based on a total mass of the positive electrode mix.

11. The positive electrode according to claim 1, wherein the carbon nanotubes are formed at an interval of 0.1 to 100 μm.

12. The positive electrode according to claim 11, wherein the carbon nanotubes are formed at a constant interval.

13. The positive electrode according to claim 11, wherein a positive electrode mix coating layer is formed by coating a slurry for the positive electrode mix after vertically growing carbon nanotubes on a surface of the current collector.

14. The positive electrode according to claim 11, wherein the positive electrode mix forms a coating layer in a state that the carbon nanotubes are embedded therein.

15. The positive electrode according to claim 11, wherein the positive electrode mix forms a coating layer to a vertically grown height of the carbon nanotubes.

16. A method of manufacturing the positive electrode according to claim 1, the method comprising:
vertically growing carbon nanotubes on a surface of a current collector;
preparing a slurry for a positive electrode mix; and
coating the slurry for the positive electrode mix on the current collector, in which the carbon nanotubes are vertically grown, and then drying the same.

17. The method according to claim 16, wherein the vertically growing is carried out by forming catalyst concentration areas, at an interval of 0.1 to 100 μm, in the current collector and vertically growing the carbon nanotubes in each of the catalyst concentration areas.

18. The method according to claim 17, wherein an interval between the catalyst concentration areas is constant.

19. A lithium secondary battery comprising the positive electrode according to claim 1.

20. A battery pack comprising the lithium secondary battery according to claim 19.

21. A device comprising the battery pack according to claim 20.

22. The device according to claim 21, wherein the device is a computer, a mobile phone, a wearable electronic device, a power tool, an electric vehicle (EV), a hybrid electric vehicle, a plug-in hybrid electric vehicle, an electric two-wheeled vehicle, an electric golf cart or a system for storing power.
